(19) United States
(12) Patent Application Publication
(10) Pub. No.: US 2016/0184903 A1
(43) Pub. Date: Jun. 30, 2016

(54) Blade fastening device with arrangement for guiding cutting fluid to cutting site

(71) Applicant: X'POLE PRECISION TOOLS INC., Taoyuan County (TW)

(72) Inventor: Peter CHEN, Taoyuan County (TW)

(21) Appl. No.: 14/583,171

(22) Filed: Dec. 25, 2014

(51) Int. Cl. B23B 31/20

(52) U.S. Cl. CPC B23B 31/20; B23B 2231/24; B23B 2231/2083

(57) ABSTRACT

A blade fastening device is provided with a holding member including an axial channel for disposing a blade, and spaced, longitudinal clamping sections on an outer surface for clamping the blade; a hollow, cylindrical clamping member for clamping the clamping sections; and a cutting fluid guide member releasably secured to a front portion of the clamping member and including an axial channel for receiving a portion of the blade, and at least one through hole extending from a front surface of an edge portion of the cutting fluid guide member to a rear surface thereof. Each through hole further communicates with one of at least one gap each between two adjacent clamping sections so that cutting fluid may pump through the at least one gap and the at least one through hole to a front portion of the blade.

### BACKGROUND OF THE INVENTION

1. Field of the invention

The invention relates to blade fastening devices and more particularly to such a blade fastening device having an arrangement for guiding cutting fluid to a cutting site for clearing swarf.

2. Description of Related Art

CNC (computer numerical control) lathes are widely employed as technologies advance. The CNC lathes can perform cutting, drilling, etc. on an object. For example, a lathe may be required to cut an object by using one of different blades.

Blade fastening device plays a big role when operating the CNC lathe. Typically, the blade fastening device has an axial channel for pumping cutting fluid to a cutting side. However, the pumping strength is relatively weak due to its axial location. Thus, more cutting fluid is required to achieve the desired clearing of swarf left at the cutting site.

Thus, the need for improvement still exists.

### SUMMARY OF THE INVENTION

It is therefore one object of the invention to provide a blade fastening device comprising a holding member including an axial channel for disposing a blade, and a plurality of spaced, longitudinal clamping sections on an outer surface, the clamping sections being configured to clamp the blade; a clamping member for clamping the clamping sections, the clamping member being shaped as a hollow cylinder; and a cutting fluid guide member releasably secured to a front portion of the clamping member and including an axial channel for receiving a portion of the blade, and at least one through hole; wherein the at least one through hole extends from a front surface of an edge portion of the cutting fluid guide member to a rear surface thereof; and wherein each of the at least one through hole further communicates with one of at least one gap each between two adjacent clamping sections so that cutting fluid is configured to pump through the at least one gap and the at least one through hole to a front portion of the blade.

Preferably, the clamping member includes internal threads on a front portion, and wherein the channel is internally threaded so that the channel is configured to threadedly secure to the internal threads of the clamping member.

Preferably, the at least one through hole comprises two through holes.

Preferably, the through holes are opposite.

Preferably, further comprises at least one plug each configured to block one of the at least one through hole.

It is envisaged by the invention that the blade fastening device has an arrangement for guiding cutting fluid to a front portion of a blade so that swarf can be effectively cleared in operation.

### BRIEF DESCRIPTION OF THE DRAWINGS

The invention, as well as its many advantages, may be further understood by the following detailed description and drawings in which:

FIG. 1 is a perspective view of a blade fastening device according to the invention;

FIG. 2 is an exploded view of the blade fastening device;

FIG. 3 is a longitudinal sectional view of the blade fastening device and a mounted blade together secured to a blade seat according to a first preferred embodiment of the invention; and

FIG. 4 is a longitudinal sectional view of the blade fastening device and a mounted blade together secured to a blade seat according to a second preferred embodiment of the invention.

### DETAILED DESCRIPTION OF THE INVENTION

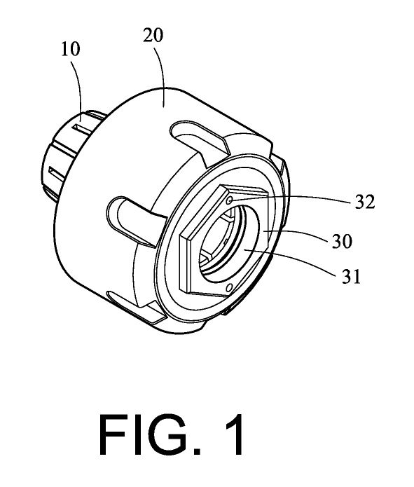

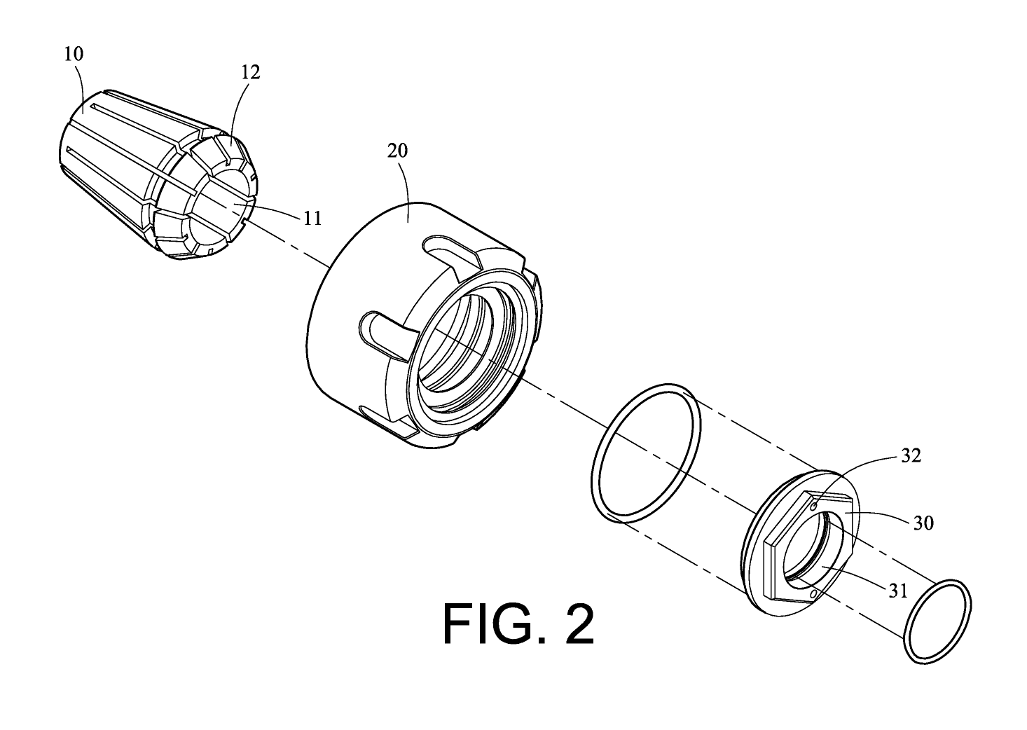

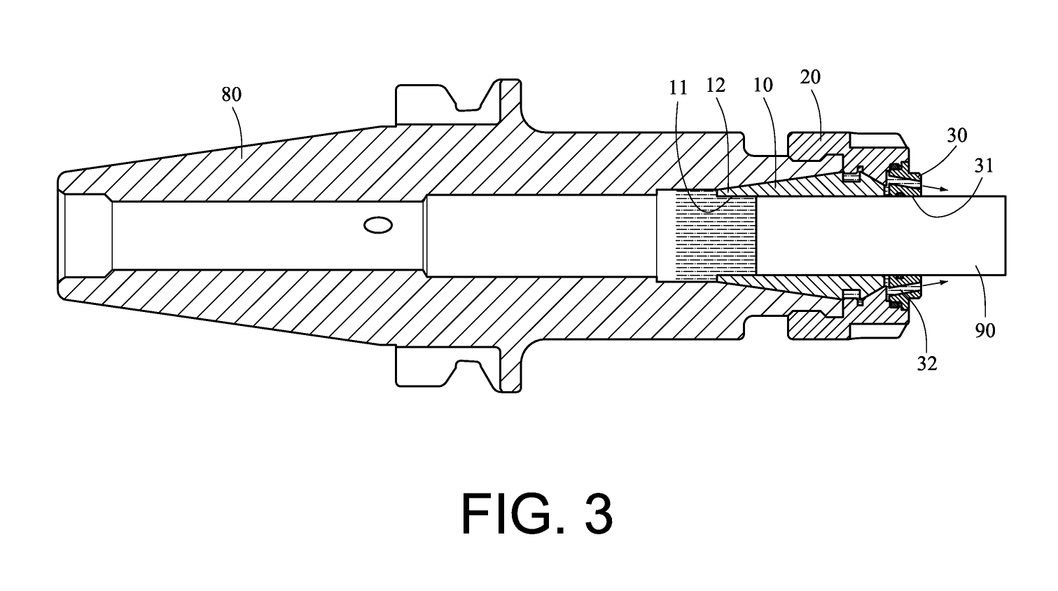

Referring to FIGS. 1 to 3, a blade fastening device in accordance with the invention comprises a holding member 10, a clamping member 20, and a cutting fluid guide member 30 as discussed in detail below.

The holding member 10 includes an axial channel 11 for disposing a blade 90, and a plurality of spaced, longitudinal clamping sections 12 on an outer surface. The clamping sections 12 are adapted to contract to clamp the blade 90. Also, cutting fluid may flow through gaps each between two adjacent clamping sections 12.

The clamping member 20 is implemented as a hollow cylinder and has threads on an inner surface adjacent to one end. The cutting fluid guide member 30 is adapted to receive a portion of the blade 90 and includes a partially, internally threaded channel 31 threadedly secured to the clamping member 20, and at least one through hole (e.g., two opposite through holes as shown) 32 extending from a front surface of an edge portion of the channel 31 to a rear surface thereof. The through holes 32 further communicate with each gap between the two adjacent clamping sections 12.

The assembled holding member 10 and the clamping member 20 together are secured to a blade seat 80. Thus, cutting fluid (as indicated by arrows) may pump through the gaps and the through holes 32 to a cutting site which is located in a front portion of the blade 90.

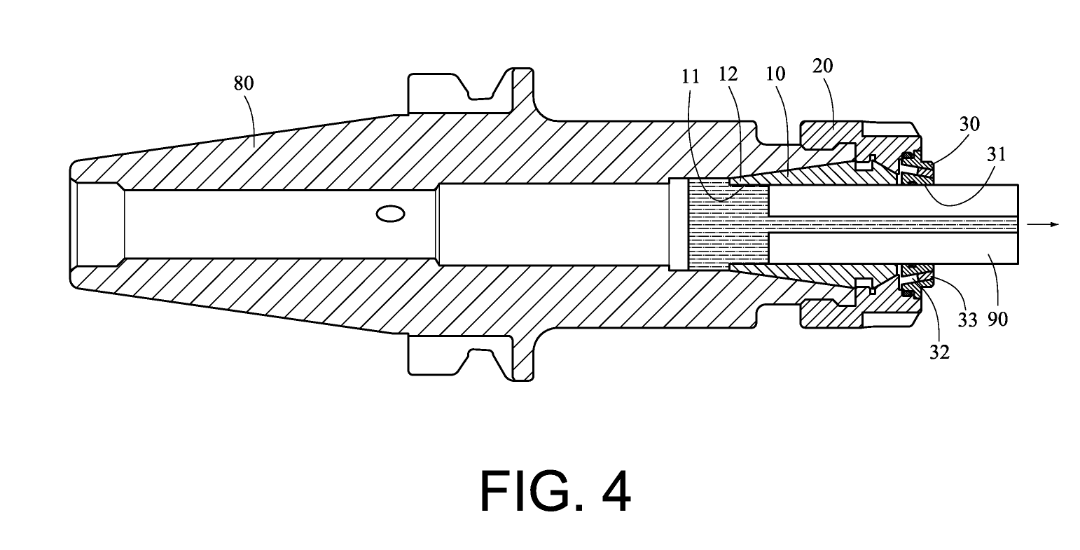

Referring to FIG. 4, a blade fastening device in accordance with a second preferred embodiment of the invention is shown. The characteristics of the second preferred embodiment are substantially the same as that of the first preferred embodiment except the following: Each of the at least one through hole 32 can be blocked by a plug 33. This allows a user to decide whether it is necessary to flow pumped cutting fluid through the at least one through hole 32 or not. Further, the pumped cutting fluid may flow through an axial channel (not numbered) of the blade 90 (as indicated by arrow).

It is envisaged by the invention that the blade fastening device has an arrangement for guiding cutting fluid to a cutting site (e.g., a front portion of a blade) so that swarf can be effectively cleared in operation.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A blade fastening device comprising:
a holding member including an axial channel for disposing a blade, and a plurality of spaced, longitudinal clamping sections on an outer surface, the clamping sections being configured to clamp the blade;
a clamping member for clamping the clamping sections, the clamping member being shaped as a hollow cylinder; and
a cutting fluid guide member releasably secured to a front portion of the clamping member and including an axial channel for receiving a portion of the blade, and at least one through hole;
wherein the at least one through hole extends from a front surface of an edge portion of the cutting fluid guide member to a rear surface thereof; and
wherein each of the at least one through hole further communicates with one of at least one gap each between two adjacent clamping sections so that cutting fluid is configured to pump through the at least one gap and the at least one through hole to a front portion of the blade.

2. The blade fastening device of claim 1, wherein the clamping member includes internal threads on a front portion, and wherein the channel is internally threaded so that the channel is configured to threadedly secure to the internal threads of the clamping member.

3. The blade fastening device of claim 1, wherein the at least one through hole comprises two through holes.

4. The blade fastening device of claim 3, wherein the through holes are opposite.

5. The blade fastening device of claim 1, further comprising at least one plug each configured to block one of the at least one through hole.
